(19) United States
(12) Patent Application Publication
(10) Pub. No.: US 2025/0155465 A1
(43) Pub. Date: May 15, 2025

(54) MECHANICAL LOW-PASS FILTER AND FREQUENCY CUT-OFF APPARATUS INCLUDING THE SAME

(71) Applicant: AGENCY FOR DEFENSE DEVELOPMENT, Daejeon (KR)

(72) Inventors: Won Young UHM, Daejeon (KR); Yongjun CHO, Daejeon (KR); Sang Hee YOON, Incheon (KR); Sehwan SONG, Incheon (KR); Youlim LEE, Incheon (KR); Junyong JANG, Daejeon (KR)

(73) Assignee: AGENCY FOR DEFENSE DEVELOPMENT, Daejeon (KR)

(21) Appl. No.: 18/823,479

(22) Filed: Sep. 3, 2024

(30) Foreign Application Priority Data
Nov. 9, 2023 (KR) 10-2023-0154483

(51) Int. Cl. G01P 1/00; G01P 1/02

(52) U.S. Cl. CPC G01P 1/003; G01P 1/023

(57) ABSTRACT

A mechanical low-pass filter positioned between a vibration source, which generates a high-energy phenomenon, and an acceleration sensor is provided. The mechanical low-pass filter is placed on one side of the acceleration sensor and is formed of an elastomer and configured to absorb an external vibration transmitted to the acceleration sensor, to filter out a frequency higher than a cut-off frequency, and to remove an influence of a high-frequency excitation. The cut-off frequency is adjustable by a number and size of through holes formed in an interior of the mechanical low-pass filter and an initial compression strain.

### CROSS-REFERENCE TO RELATED APPLICATION

This application claims the benefit of Korean Patent Application No. 10-2023-0154483 filed on Nov. 9, 2023, in the Korean Intellectual Property Office, the entire disclosure of which is incorporated herein by reference for all purposes.

### BACKGROUND

### 1. Field of the Invention

One or more embodiments relate to a mechanical low-pass filter and a frequency cut-off apparatus including the same.

### 2. Description of the Related Art

Problems with an acceleration sensor (e.g., physical damage due to resonance, zero shift, and non-linear output characteristics) caused by a high-frequency noise signal that exists in high-energy phenomena such as an explosion that may occur during military training or an engine inside a military aircraft have been solved by improving a natural frequency of the acceleration sensor, introducing attenuation within a sensing portion of an acceleration sensor, limiting a maximum displacement of a sensing portion, and the like. A method of increasing the natural frequency of the acceleration sensor is ineffective when an excitation frequency of a vibration source is higher than the natural frequency of the acceleration sensor and requires a high level of design technology. A method of introducing fluid damping in a sensing portion of an acceleration sensor is complex and requires a high level of microfabrication technology. A method of limiting the maximum displacement of a sensing portion of the acceleration sensor using microstructures such as a mechanical stopper has problems such as physical damage due to a vibration signal, reduction of a measurement range of the acceleration sensor, limited effects, and the like. In addition, existing solutions are commonly applied from a design stage of an acceleration sensor, so they have the inherent limitation of not being applicable to a commercial acceleration sensor.

When employing an electrical low-pass filter, since the electrical low-pass filter is an element applied to an outputter of an acceleration sensor, the electrical low-pass filter may not block a high-frequency signal from being transmitted from a vibration source to the acceleration sensor and may thus not protect the acceleration sensor from problems of the acceleration sensor caused by a high-frequency vibration environment. When a mechanical low-pass filter is placed between a vibration source and an inputter of an acceleration sensor and a cut-off frequency of the mechanical low-pass filter is adjusted to be higher than a frequency of an acceleration signal to be measured and lower than a noise frequency in a high-energy phenomenon, a problem caused by a high-frequency noise signal may be solved and the accuracy, reliability, and repeatability of acceleration measurement may be improved. In addition, a mechanical low-pass filter may be made of various materials such as foam, metal, ceramic, and elastomer, but metal and ceramic have low vibration attenuation performance and are not easy to form, and ceramic in particular has poor impact resistance properties. Therefore, an appropriate material for application to a mechanical low-pass filter for an acceleration sensor needs to be selected.

Korean Patent No. 10-0882772 (registered on Feb. 9, 2009) discloses a power divider provided with a low-pass filter based on a radio-frequency identification (RFID) system.

The above description is information the inventor(s) acquired during the course of conceiving the present disclosure, or already possessed at the time, and is not necessarily art publicly known before the present application was filed.

### SUMMARY

Embodiments provide a frequency cut-off apparatus capable of controlling a cut-off frequency by adjusting a shape and a compression characteristic of a mechanical low-pass filter.

Embodiments provide a frequency cut-off apparatus capable of transmitting only a vibration having a frequency component equal to or lower than a cut-off frequency to an acceleration sensor without a separate power supply.

According to an aspect, there is provided a mechanical low-pass filter positioned between a vibration source, which generates a high-energy phenomenon, and an acceleration sensor, wherein the mechanical low-pass filter is placed on one side of the acceleration sensor and formed of an elastomer and configured to absorb an external vibration transmitted to the acceleration sensor, to filter out a frequency higher than a cut-off frequency, and to remove an influence of a high-frequency excitation.

At least one hole may be formed penetrating an interior of the mechanical low-pass filter in a direction parallel to a direction of a transmission of a vibration.

The mechanical low-pass filter may be compressed in a direction parallel to a direction of a transmission of a vibration.

According to an aspect, there is provided a frequency cut-off apparatus including a housing portion and a sensing portion that is placed in an interior of the housing portion and configured to measure acceleration, wherein the sensing portion includes an acceleration sensor configured to sense acceleration and a mechanical low-pass filter placed on one side of the acceleration sensor, formed of an elastomer, and configured to absorb an external vibration transmitted to the acceleration sensor.

The housing portion may include a lower frame including an accommodating space in an interior and an open upper end, and an upper frame configured to cover the open upper end of the lower frame.

The sensing portion may further include a compression means placed in an interior of the housing portion and configured to compress the mechanical low-pass filter.

The mechanical low-pass filter may be placed on an upper portion and a lower portion of the acceleration sensor, a portion of the upper frame may protrude toward the lower frame, and the sensing portion may be pressed and fixed in a position by the lower frame and the protruding portion of the upper frame.

The mechanical low-pass filter may be placed on an upper portion and a lower portion of the acceleration sensor, a portion of the lower frame may protrude toward the upper frame, and the sensing portion may be pressed and fixed in a position by the upper frame and the protruding portion of the lower frame.

The mechanical low-pass filter may be placed on an upper portion and a lower portion of the acceleration sensor, a portion of the lower frame may protrude toward the upper frame, a portion of the upper frame may protrude toward the lower frame, and the sensing portion may be pressed and fixed in a position by the protruding portion of the lower frame and the protruding portion of the upper frame.

The mechanical low-pass filter may be placed on an upper portion and a lower portion of the acceleration sensor, and the sensing portion may be pressed and fixed in a position by the lower frame and the upper frame.

At least one hole may be formed penetrating an interior of the mechanical low-pass filter in a direction parallel to a direction of a transmission of a vibration.

The mechanical low-pass filter may be compressed in a direction parallel to a direction of a transmission of a vibration.

Additional aspects of embodiments will be set forth in part in the description which follows and, in part, will be apparent from the description, or may be learned by practice of the disclosure.

According to embodiments, a frequency cut-off apparatus may control a cut-off frequency by adjusting a shape and a compression characteristic of a mechanical low-pass filter.

According to embodiments, a frequency cut-off apparatus may transmit only a vibration having a frequency component equal to or lower than a cut-off frequency to an acceleration sensor without a separate power supply.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a frequency cut-off apparatus according to an embodiment;

FIG. 2 is a perspective view of a mechanical low-pass filter according to an embodiment;

FIG. 3 is a side view of a mechanical low-pass filter according to another embodiment;

FIG. 4A is a graph illustrating a change in a cut-off frequency according to a number of holes of a mechanical low-pass filter, according to another embodiment, FIG. 4B is a graph illustrating a change in a cut-off frequency according to a hole size of a mechanical low-pass filter, according to another embodiment, and FIG. 4C is a graph illustrating a change in a cut-off frequency according to an initial compression strain of a mechanical low-pass filter, according to another embodiment;

FIG. 5 is a diagram illustrating a frequency cut-off apparatus according to an embodiment;

FIG. 6 is a diagram illustrating a frequency cut-off apparatus according to another embodiment;

FIG. 7 is a diagram illustrating a frequency cut-off apparatus according to another embodiment;

FIG. 8 is a diagram illustrating a frequency cut-off apparatus according to another embodiment; and

FIG. 9 is a diagram illustrating a frequency cut-off apparatus according to another embodiment.

### DETAILED DESCRIPTION

Hereinafter, embodiments of the present disclosure are described in detail with reference to the accompanying drawings. Regarding the reference numerals assigned to the components in the drawings, it should be noted that the same components are designated by the same reference numerals, wherever possible, even though they are shown in different drawings. Also, in the description of the embodiments, detailed description of well-known related structures or functions is omitted when it is deemed that such description will cause ambiguous interpretation of the present disclosure.

In addition, in the description of the components of the embodiments, terms such as first, second, A, B, (a), (b), and the like may be used. These terms are used only for the purpose of discriminating one component from another component, and the nature, the sequences, the orders, or the like of the components are not limited by the terms. It is to be understood that if a component is described as being “connected,” “coupled,” or “joined” to another component, the former may be directly “connected,” “coupled,” or “joined” to the latter or “connected,” “coupled,” or “joined” to the latter via another component.

The same name may be used to describe components having a common function in different embodiments. Unless otherwise mentioned, the description of one embodiment may be applicable to another embodiment. Thus, duplicated description is omitted for conciseness.

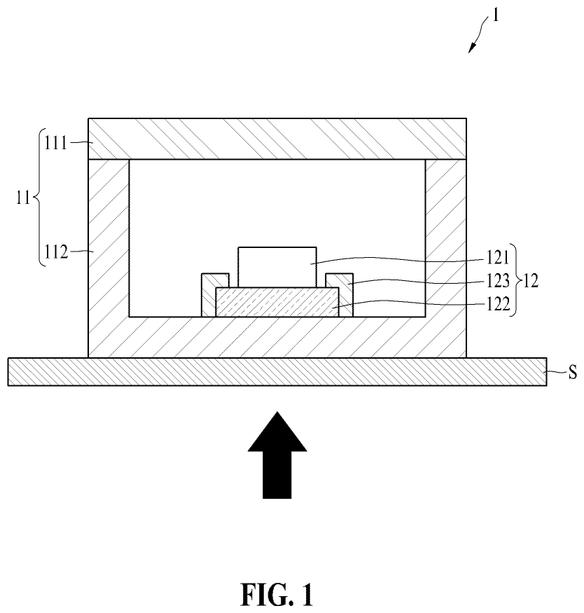

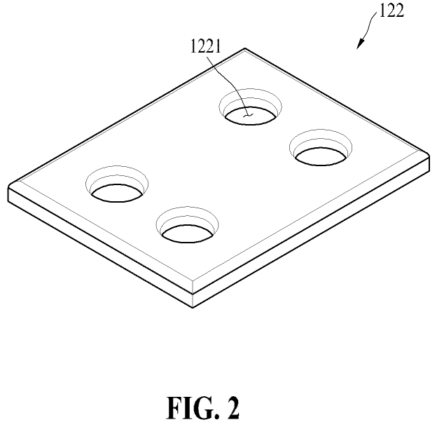

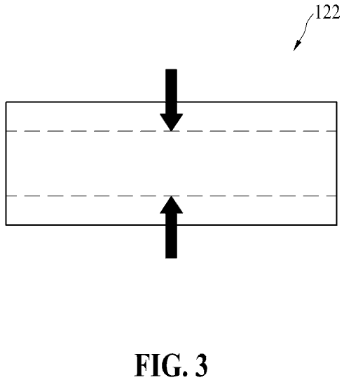

FIG. 1 is a diagram illustrating a frequency cut-off apparatus according to an embodiment, FIG. 2 is a perspective view of a mechanical low-pass filter according to an embodiment, and FIG. 3 is a side view of a mechanical low-pass filter according to another embodiment.

In measuring high-frequency acceleration accompanying high-energy phenomena, improving accuracy, reliability, and repeatability of high-frequency acceleration measurement may be very important. An acceleration signal generated from an explosion, a metal-metal collision, a penetration, and the like may have a significant component at the 20 kHz level and may even include high-frequency noise of 100 kHz or more. Referring to FIGS. 1 to 3, a frequency cut-off apparatus 1 may control a cut-off frequency by adjusting a shape and a compression characteristic of a mechanical low-pass filter 122. In addition, the frequency cut-off apparatus 1 may transmit only a vibration having a frequency component equal to or lower than the cut-off frequency to an acceleration sensor without a separate power supply. That is, by adjusting the cut-off frequency, only a vibration having a frequency component equal to or lower than the cut-off frequency, among vibrations transmitted from a vibration source S, may be transmitted to an acceleration sensor 121. Through a placement of components as shown in FIG. 1, only a vibration, among vertically upward vibrations, having a frequency component equal to or lower than the cut-off frequency may be transmitted to the acceleration sensor 121. For example, the frequency cut-off apparatus 1 may include a housing portion 11 and a sensing portion 12.

The housing portion 11 may include a lower frame 112 and an upper frame 111, wherein the lower frame 112 has an accommodating space therein and an open upper end, and the upper frame 111 covers the open upper end of the lower frame 112.

The sensing portion 12 may be placed in an interior of the housing portion 11 and may measure acceleration. For example, the sensing portion 12 may include the acceleration sensor 121, the mechanical low-pass filter 122, and a compression means 123.

The acceleration sensor 121 may sense an acceleration of a location at which the acceleration sensor 121 is placed. The acceleration sensor 121 may measure a degree of movement, tilt, and vibration of an object.

The mechanical low-pass filter 122 may be placed on one side of the acceleration sensor 121 and may be made of an elastomer to absorb an external vibration transmitted to the acceleration sensor 121. The elastomer may absorb or dissipate an external vibration based on friction between an internal surface that may slide as deformation occurs. When absorbing an external vibration, the elastomer may attenuate a vibration having a frequency higher than a specific cut-off frequency and pass a vibration signal having a frequency equal to or lower than the cut-off frequency. The mechanical low-pass filter 122 may be positioned between the vibration source S and an input terminal of the acceleration sensor and may block high-frequency acceleration noise that is higher than the cut-off frequency of the mechanical low-pass filter 122, thereby enabling measurement with high reliability and high repeatability. The cut-off frequency of an elastomer may be determined by physical properties of the material, such as storage modulus and loss modulus, and a thickness in a direction of a vibration transmission, but may also be adjusted by a number and size of through holes formed in an interior of the mechanical low-pass filter 122 and an initial compression strain. For example, the mechanical low-pass filter 122 may have at least one hole 1221 penetrating an interior of the mechanical low-pass filter 122 in a direction parallel to a direction of a transmission of vibration. In addition, as shown in FIG. 3, the mechanical low-pass filter 122 may be compressed in a direction parallel to the direction of the transmission of vibration.

The compression means 123 may be placed in an interior of the housing portion 11 and may compress the mechanical low-pass filter 122. For example, the compression means 123 may be placed on either side of the mechanical low-pass filter 122 and may press the mechanical low-pass filter 122 in a clamping manner, thereby compressing the mechanical low-pass filter 122. The compression means 123 may adjust a clamping strength so that a compression rate of the mechanical low-pass filter 122 may be controlled to suit a design of the mechanical low-pass filter 122.

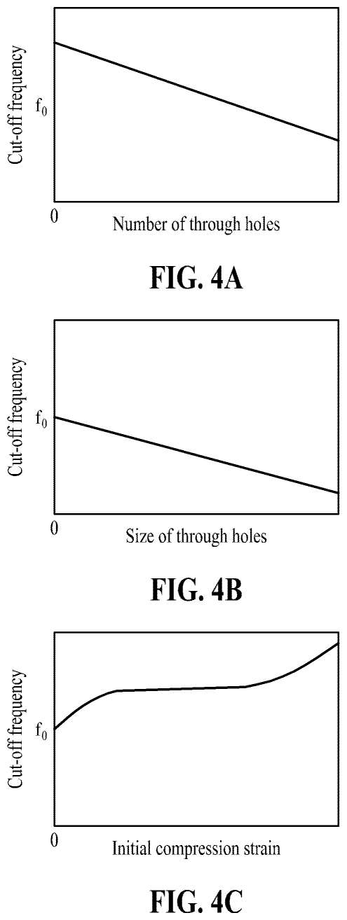

FIG. 4A is a graph illustrating a change in a cut-off frequency according to a number of holes of a mechanical low-pass filter, according to another embodiment, FIG. 4B is a graph illustrating a change in a cut-off frequency according to a hole size of a mechanical low-pass filter, according to another embodiment, and FIG. 4C is a graph illustrating a change in a cut-off frequency according to an initial compression strain of a mechanical low-pass filter, according to another embodiment.

Referring to FIG. 4A, as a number of the holes 1221 penetrating the mechanical low-pass filter 122 increases, a cut-off frequency of the mechanical low-pass filter 122 may decrease. Since the hole 1221 of the mechanical low-pass filter 122 may be viewed as being formed of an air layer, a size of the cut-off frequency blocked by the mechanical low-pass filter 122 may be reduced.

Referring to FIG. 4B, as a size of the hole 1221 that penetrates the mechanical low-pass filter 122 increases, the cut-off frequency of the mechanical low-pass filter 122 may decrease. As in FIG. 4A, since the hole 1221 of the mechanical low-pass filter 122 may be viewed as being formed of an air layer, the size of the cut-off frequency blocked by the mechanical low-pass filter 122 may be reduced.

Referring to FIG. 4C, as the initial compression strain of the mechanical low-pass filter 122 increases, the cut-off frequency of the mechanical low-pass filter 122 may increase. When the mechanical low-pass filter 122 is compressed and a density increases, the cut-off frequency blocked by the mechanical low-pass filter 122 may increase.

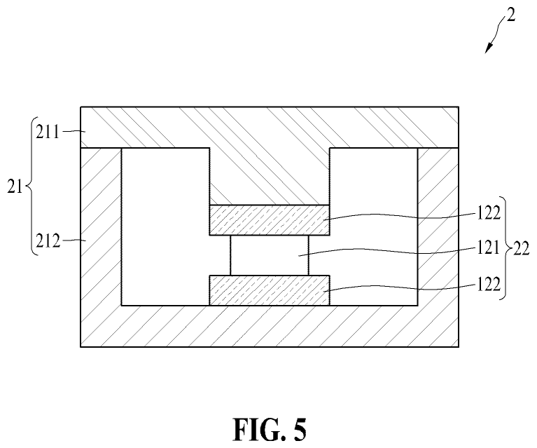

FIG. 5 is a diagram illustrating a frequency cut-off apparatus according to an embodiment.

Referring to FIG. 5, the frequency cut-off apparatus 2 may include a housing portion 21 and a sensing portion 22. The mechanical low-pass filter 122 may be placed on an upper portion and a lower portion of the acceleration sensor 121. A portion of an upper frame 211 may protrude toward a lower frame 212, and the sensing portion 22 may be pressed and fixed in a position by the lower frame 212 and the protruding portion of the upper frame 211. According to this structure, even when the compression means 123 is not provided, the mechanical low-pass filter 122 may be compressed by the housing portion 21. In this case as well, depending on the design, the holes 1221 may be formed inside the mechanical low-pass filter 122, and a number and size of the holes 1221 may vary. The frequency cut-off apparatus 2 according to FIG. 5 may allow only a vibration, among vertically downward vibrations as well as vertically upward vibrations, having a frequency component equal to or lower than the cut-off frequency to be transmitted to the acceleration sensor 121.

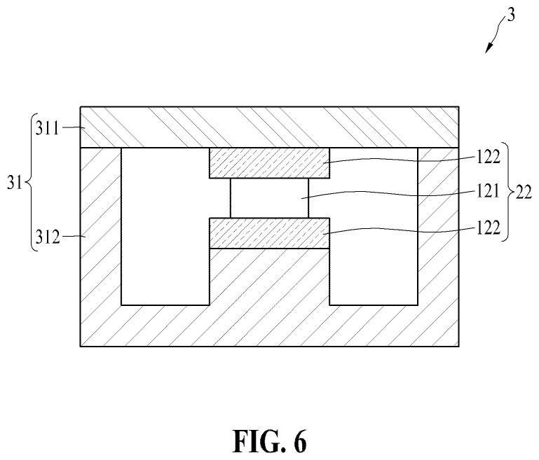

FIG. 6 is a diagram illustrating a frequency cut-off apparatus according to another embodiment.

Referring to FIG. 6, a frequency cut-off apparatus 3 may include a housing portion 31 and a sensing portion 22. The mechanical low-pass filter 122 may be placed on an upper portion and a lower portion of the acceleration sensor 121. A portion of a lower frame 312 may protrude toward an upper frame 311, and the sensing portion 22 may be pressed and fixed in a position by the upper frame 311 and the protruding portion of the lower frame 312. According to this structure, even when the compression means 123 is not provided, the mechanical low-pass filter 122 may be compressed by the housing portion 31. In this case as well, depending on the design, the holes 1221 may be formed inside the mechanical low-pass filter 122, and a number and size of the holes 1221 may vary. The frequency cut-off apparatus 3 according to FIG. 6 may allow only a vibration, among vertically downward vibrations as well as vertically upward vibrations, having a frequency component equal to or lower than the cut-off frequency to be transmitted to the acceleration sensor 121.

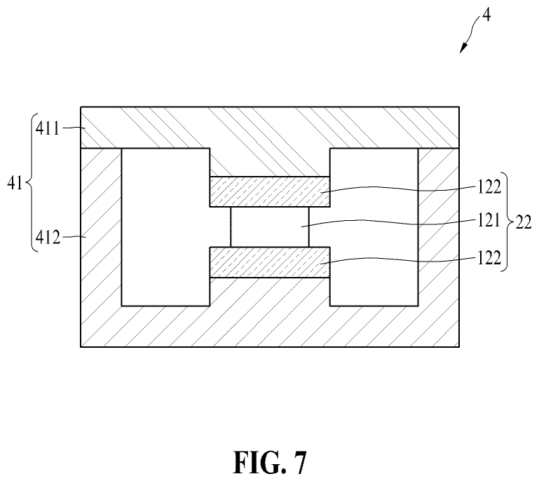

FIG. 7 is a diagram illustrating a frequency cut-off apparatus according to another embodiment.

Referring to FIG. 7, the frequency cut-off apparatus 4 may include a housing portion 41 and the sensing portion 22. The mechanical low-pass filter 122 may be placed on an upper portion and a lower portion of the acceleration sensor 121. A portion of an upper frame 411 may protrude toward a lower frame 412, a portion of the lower frame 412 may protrude toward the upper frame 411, and the sensing portion 22 may be pressed and fixed in a position by the protruding portion of the upper frame 411 and the protruding portion of the lower frame 412. According to this structure, even when the compression means 123 is not provided, the mechanical low-pass filter 122 may be compressed by the housing portion 41. In this case as well, depending on the design, the holes 1221 may be formed inside the mechanical low-pass filter 122, and a number and size of the holes 1221 may vary. The frequency cut-off apparatus 4 according to FIG. 7 may allow only a vibration, among vertically downward vibrations as well as vertically upward vibrations, having a frequency component equal to or lower than the cut-off frequency to be transmitted to the acceleration sensor 121.

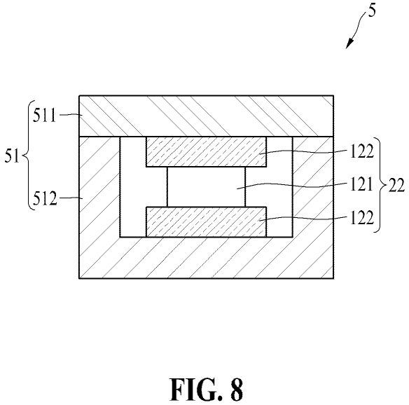

FIG. 8 is a diagram illustrating a frequency cut-off apparatus according to another embodiment.

Referring to FIG. 8, a frequency cut-off apparatus 5 may include a housing portion 51 and the sensing portion 22. The mechanical low-pass filter 122 may be placed on an upper portion and a lower portion of the acceleration sensor 121. The sensing portion 22 may be pressed and fixed in a position by an upper frame 511 and a lower frame 512. According to this structure, even when the compression means 123 is not provided, the mechanical low-pass filter 122 may be compressed by the housing portion 51. In this case as well, depending on the design, the holes 1221 may be formed inside the mechanical low-pass filter 122, and a number and size of the holes 1221 may vary. The frequency cut-off apparatus 5 according to FIG. 8 may allow only a vibration, among vertically downward vibrations as well as vertically upward vibrations, having a frequency component equal to or lower than the cut-off frequency to be transmitted to the acceleration sensor 121.

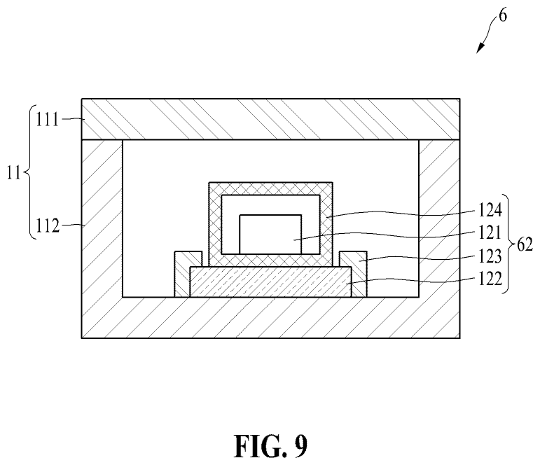

FIG. 9 is a diagram illustrating a frequency cut-off apparatus according to another embodiment.

Referring to FIG. 9, a frequency cut-off apparatus 6 may include a housing portion 11 and a sensing portion 62. The housing portion 11 may include an upper frame 111 and a lower frame 112, and the sensing portion 62 may include the acceleration sensor 121, the mechanical low-pass filter 122, a compression means 123, and a sensor frame 124.

The sensor frame 124 may be a part that accommodates the acceleration sensor 121 therein. For example, the acceleration sensor 121 covered by the sensor frame 124 may refer to a sensor for measuring acceleration, which is generally available on the market. In other words, a commercial acceleration measuring sensor may be applied to the frequency cut-off apparatus 6 without any additional design change. The frequency cut-off apparatus 6 according to FIG. 9 may allow only a vibration, among vertically upward vibrations, having a frequency component equal to or lower than the cut-off frequency to be transmitted to the acceleration sensor 121.

Instead of the acceleration sensor 121 shown in FIGS. 5 to 8, the sensor frame 124 that accommodates the acceleration sensor 121 therein may be employed. Specifically, (i) the mechanical low-pass filter 122 may be provided on an upper portion and a lower portion of the sensor frame 124, a portion of the upper frame 211 may protrude toward the lower frame 212, and the mechanical low-pass filter 122 provided on the upper portion and a lower portion of the sensor frame 124 may be pressed and fixed in a position by the lower frame 212 and the protruding portion of the upper frame 211. Alternatively, (ii) the mechanical low-pass filter 122 may be placed on the upper portion and the lower portion of the sensor frame 124, a portion of the lower frame 312 may protrude toward the upper frame 311, and the mechanical low-pass filter 122 placed on the upper portion and the lower portion of the sensor frame 124 may be pressed and fixed in a position by the upper frame 311 and the protruding portion of the lower frame 312. (iii) The mechanical low-pass filter 122 may be placed on the upper portion and the lower portion of the sensor frame 124, a portion of the upper frame 411 may protrude toward the lower frame 412, a portion of the lower frame 412 may protrude toward the upper frame 411, and the mechanical low-pass filter 122 placed on the upper portion and the lower portion of the sensor frame 124 may be pressed and fixed in a position by the protruding portion of the upper frame 411 and the protruding portion of the lower frame 412. (iv) The mechanical low-pass filter 122 may be placed on the upper portion and the lower portion of the sensor frame 124, and the mechanical low-pass filter 122 placed on the upper portion and the lower portion of the sensor frame 124 may be pressed and fixed in a position by the upper frame 511 and the lower frame 512. According to this structure, even when the compression means 123 is not provided, the mechanical low-pass filter 122 may be compressed by the housing portions 21, 31, 41, and 51. In this case as well, depending on the design, the holes 1221 may be formed inside the mechanical low-pass filter 122, and a number and size of the holes 1221 may vary. According to this placement, unlike the frequency cut-off apparatus 6 shown in FIG. 9, only a vibration, among vertically downward vibrations as well as vertically upward vibrations, having a frequency component equal to or lower than the cut-off frequency may be transmitted to the acceleration sensor 121.

Although the examples have been described with reference to the limited number of drawings, it will be apparent to one of ordinary skill in the art that various modifications and variations may be made to the examples. For example, suitable results may be achieved if the described techniques are performed in a different order, and/or if components in a described architecture, device, and the like are combined in a different manner and/or replaced or supplemented by other components or their equivalents.

What is claimed is:

1. A mechanical low-pass filter positioned between a vibration source, which generates a high-energy phenomenon, and an acceleration sensor, wherein the mechanical low-pass filter is
placed on one side of the acceleration sensor, and
is formed of an elastomer and configured to absorb an external vibration transmitted to the acceleration sensor, to filter out a frequency higher than a cut-off frequency, and to remove an influence of a high-frequency excitation.

2. The mechanical low-pass filter of claim 1, wherein at least one hole is formed penetrating an interior of the mechanical low-pass filter in a direction parallel to a direction of a transmission of a vibration.

3. The mechanical low-pass filter of claim 1, wherein the mechanical low-pass filter is compressed in a direction parallel to a direction of a transmission of a vibration.

4. A frequency cut-off apparatus comprising:
a housing portion; and
a sensing portion placed in an interior of the housing portion and configured to measure acceleration,
wherein the sensing portion comprises:
an acceleration sensor configured to sense acceleration; and
a mechanical low-pass filter placed on one side of the acceleration sensor, formed of an elastomer, and configured to absorb an external vibration transmitted to the acceleration sensor.

5. The frequency cut-off apparatus of claim 4, wherein the housing portion comprises:
a lower frame comprising an accommodating space in an interior and an open upper end; and
an upper frame configured to cover the open upper end of the lower frame.

6. The frequency cut-off apparatus of claim 5, wherein the sensing portion further comprises:
a compression means placed in an interior of the housing portion and configured to compress the mechanical low-pass filter.

7. The frequency cut-off apparatus of claim 5, wherein
the mechanical low-pass filter is placed on an upper portion and a lower portion of the acceleration sensor,
a portion of the upper frame protrudes toward the lower frame, and
the sensing portion is pressed and fixed in a position by the lower frame and the protruding portion of the upper frame.

8. The frequency cut-off apparatus of claim 5, wherein
the mechanical low-pass filter is placed on an upper portion and a lower portion of the acceleration sensor,
a portion of the lower frame protrudes toward the upper frame, and
the sensing portion is pressed and fixed in a position by the upper frame and the protruding portion of the lower frame.

9. The frequency cut-off apparatus of claim 5, wherein
the mechanical low-pass filter is placed on an upper portion and a lower portion of the acceleration sensor,
a portion of the lower frame protrudes toward the upper frame,
a portion of the upper frame protrudes toward the lower frame, and
the sensing portion is pressed and fixed in a position by the protruding portion of the lower frame and the protruding portion of the upper frame.

10. The frequency cut-off apparatus of claim 5, wherein
the mechanical low-pass filter is placed on an upper portion and a lower portion of the acceleration sensor, and
the sensing portion is pressed and fixed in a position by the lower frame and the upper frame.

11. The frequency cut-off apparatus of claim 4, wherein at least one hole is formed penetrating an interior of the mechanical low-pass filter in a direction parallel to a direction of a transmission of a vibration.

12. The frequency cut-off apparatus of claim 4, wherein the mechanical low-pass filter is compressed in a direction parallel to a direction of a transmission of a vibration.
